(19) United States
(12) Patent Application Publication
(10) Pub. No.: US 2015/0061232 A1
(43) Pub. Date: Mar. 5, 2015

(54) SEALING ARRANGEMENT FOR FOLLOWER-SHAFT ASSEMBLY

(71) Applicant: Caterpillar Inc., Peoria, IL (US)

(72) Inventor: Daniel J. Reed, Brimfield, IL (US)

(73) Assignee: Caterpillar Inc., Peoria, IL (US)

(21) Appl. No.: 14/536,730

(22) Filed: Nov. 10, 2014

(51) Int. Cl. F16J 15/32

(52) U.S. Cl. CPC F16J 15/3268
USPC 277/551

(57) ABSTRACT

A sealing arrangement is disclosed herein. The follower shaft extends within a housing to interface with the housing and senses rotational movement of a base shaft. The sealing arrangement includes a mount member and a seal member. The mount member includes a first end attached to the housing, a second end defining a seal-receiving portion, and an opening throughout. The follower shaft extends through the opening. The seal member has an outer perimeter portion that is adapted to engage with the seal receiving portion. The seal member has an inner resilient portion adapted to seal the perimeter of the follower shaft. The second end of the mount member is structured and arranged to resiliently deflect in correspondence with the resilient inner portion of the seal member. This limits the deflection of the resilient inner portion of the seal member in response to radial movement of the follower shaft.

### TECHNICAL FIELD

The present disclosure relates generally to a follower-shaft assembly. More specifically, the present disclosure relates to a sealing arrangement for the follower-shaft assembly.

### BACKGROUND

Follower-shaft assemblies are commonly known to measure rotational movement of a base shaft which may be part of a machine. A follower-shaft assembly generally includes a follower shaft attached to the base shaft and a rotation of the base shaft is determined by measurement of the rotation of the follower shaft. The follower shaft is typically positioned to extend into a housing of the machine to engage with the base shaft. Since the housing encases the rotating base shaft and is likely sealed to retain lubrication within the housing, the follower shaft may breach the sealed housing to engage with the base shaft. While being positioned in the housing, a portion of the follower shaft extends through the housing and therefore the clearance between the housing and the follower shaft may allow lubrication to leak from the housing. Therefore, a sealing arrangement is generally required to seal a gap between the follower shaft and the housing.

Conventional sealing arrangements may include a single lip-type seal, a double lip-type seal, an annular seal, a labyrinth seal, and/or the like. However, under high-speed rotation, the follower shaft also may experience a radial movement which causes the follower to “orbit” rather than rotate. The conventional sealing arrangements are generally designed to seal under rotation however when the follower shaft orbits these seals are less effective and often leakage around the seal at the shaft is common. This may also result in premature wear and failure of the sealing arrangement as the orbiting motion exceeds the radial capacity of these conventional sealing arrangements.

U.S. Pat. No. 7,997,858 discloses a sealing arrangement to seal a gap between a first component (rotating shaft) and a second component (housing). The sealing arrangement includes a sealing element and a sealing element displacement device. The sealing element displacement device includes a movable pressure element that adjusts the sealing element upon a displacement due to thermal expansion of the second component. The movable pressure element includes a first face bearing against a second inclined face of the sealing component and is attached to the second component via a screw and spring arrangement. The specific arrangement leads to displacement of the seal element upon displacement of the pressure element. However, the sealing arrangement may still fail under high speed orbiting conditions of the follower shaft.

### SUMMARY OF THE INVENTION

Various aspects of the present disclosure are directed to a sealing arrangement for a follower shaft. The follower shaft extends within a housing to interface with, and to sense rotational movement of, a base shaft. The sealing arrangement includes a mount member and a seal member. The mount member has a first end, a second end, and an opening therethrough. The first end of the mount member is attached to the housing. The second end of the mount member defines a seal receiving portion. The follower shaft is extendable through the opening in the mount member. The seal member has an outer perimeter portion and a resilient inner portion. The outer perimeter portion is adapted to engage with the seal receiving portion of the second end of the mount member. The resilient inner portion being adapted to seal a perimeter of the follower shaft. Further, the second end of the mount member is structured and arranged to resiliently deflect in correspondence with the orbiting motion of the follower shaft to preserve the seal between the resilient inner portion of the seal member and the follower shaft. Therefore, the second end of the mount member limits the deflection of the resilient inner portion of the seal member in response to radial movement of the follower shaft.

### BRIEF DESCRIPTION OF THE DRAWINGS

FIG. 1 is a cross-sectional side view of a first embodiment of a follower-shaft assembly that illustrates a sealing arrangement, employing a resilient mount member and a sealed roller bearing disposed therein to seal a gap between a follower shaft and a housing according to the present disclosure; and

FIG. 2 is a cross-sectional side view of a second embodiment of a follower-shaft assembly that illustrates the sealing arrangement, employing a resilient mount member and a lip type seal disposed therein to seal the gap between the follower shaft and the housing, according to the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

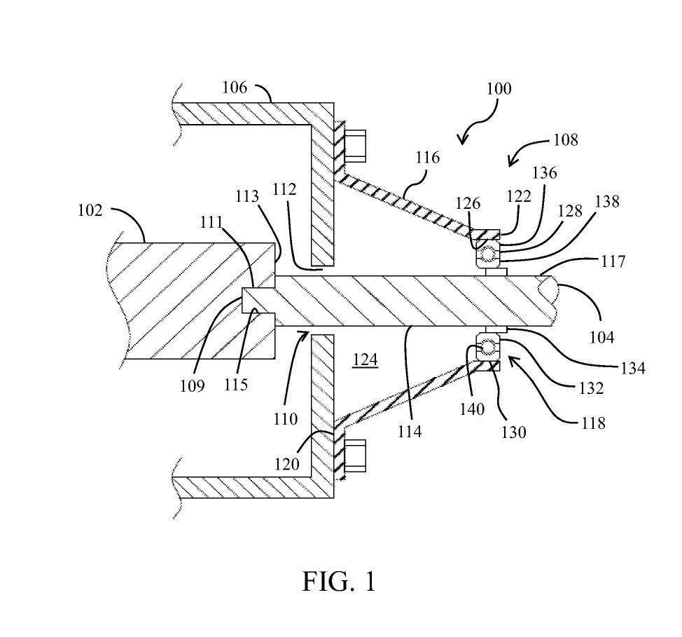

Referring to FIG. 1, there is shown a follower-shaft assembly 100 which includes a base shaft 102, a follower shaft 104, a housing 106, and a sealing arrangement 108.

The base shaft 102 which may be a rotating shaft that is a primary component of a machine (not shown) for example, is enclosed within the housing 106. The housing 106 may include lubricant for lubricating rotating components such as the base shaft 102. The follower-shaft assembly 100 is attached to the housing 106 and includes the follower shaft 104 which extends through a hole 110 in the housing 106 to engage with the base shaft 102. The follower-shaft assembly 100 may extend into the housing 106 of any machine, such as, but not limited to an internal combustion engine, a transmission, a turbine, a compressor or any other device which incorporates rotating shaft machinery within a lubrication or otherwise sealed compartment. In an exemplary embodiment, the base shaft 102 may be an axle shaft of an electrically driven construction machine for example and the follower shaft rotational speed may be used for velocity input into the machine's ECM as an input indicative of machine speed. It may be required to continuously monitor rotation associated with the base shaft 102 in certain machines, however cumbersome to directly measure base shaft rotation.

In an exemplary embodiment of the present disclosure, the follower shaft 104 includes an end 109, which may include a notched portion 111 that is coupled to an end 113 of the base shaft 102, having a keyway slot 115, for example, to receive the notched portion 111 of the follower shaft 104. It will be understood that the follower shaft 104 may be coupled to the base shaft 102 or alternatively, may be fixed to the base shaft 102 though a threaded engagement. The follower shaft 104 tracks the rotation of the base shaft 102. Therefore, the rotation associated with the base shaft 102 may be monitored by measuring the rotation associated with the follower shaft 104. It is envisioned that the present disclosure contemplates alternative attachments between the end 109 of the follower shaft 104 and the end 113 of the base shaft 102, such as for example, press fit, welding, or any other shaft attachment known to those with ordinary skill in the art.

The base shaft 102 and the follower shaft 104 are positioned such that a portion of the follower shaft 104 extends into the housing 106, however a substantial amount of the follower shaft 104 is external to the housing 106. The portion of the follower shaft 104 extend out via the hole 110 in the housing 106. The hole 110 is generally larger in diameter than the follower shaft 104 and therefore defines a gap 112 between the follower shaft 104 and the housing 106, when measured radially. It may be seen that a portion 117 of the follower shaft 104 may be connected to a rotational sensor (not shown) as is customary.

The sealing arrangement 108 is provided to prevent lubrication originating from the gap 112 (between the follower shaft 104 and the housing 106) from exiting the follower-shaft assembly 100. The sealing arrangement 108 is positioned about a perimeter 114 of the follower shaft 104 however spaced from the housing 106. The sealing arrangement 108 prevents lubricant from leaking from the housing 106 and spilling in the vicinity of the housing 106. The sealing arrangement 108 includes a mount member 116 and a seal member 118.

The mount member 116 may be frusto-conical in shape and is comprised of a resilient material. The mount member 116 is axially aligned with the follower shaft 104 and includes a first end 120, a second end 122, and an opening 124 between the first end 120 and the second end 122. The first end 120 of the mount member 116 is attached to the housing 106, while the follower shaft 104 extends through the opening 124 of the mount member 116, and the second end 122 defines a seal receiving portion 126.

The seal member 118 may include a sealed roller bearing 128 disposed in the seal receiving portion 126 of the mount member 116. The seal member 118 includes an outer perimeter portion 130 and a resilient inner portion 132. The outer perimeter portion 130 of the seal member 118 engages with the seal receiving portion 126 of the mount member 116. The resilient inner portion 132 is adapted to seal the perimeter 114 of the follower shaft 104. A rubber tube 134 is inserted between the resilient inner portion 132 and the perimeter 114 of the follower shaft 104, to seal the resilient inner portion 132 with the perimeter 114 of the follower shaft 104. More particularly, the sealed roller bearing 128 includes an outer ring member 136, an inner ring member 138 and uniformly spaced ball bearings 140. The inner ring member 138 seals and rotates with the rubber tube 134 and the outer ring member 136 is stationary and forms a seal with the second end 122 of the mount member 116.

In assembly, the seal member 118 is mounted in the second end 122 of the mount member 116. The second end 122 being made of a resilient material, is designed to resiliently deflect in correspondence with the follower shaft 104 as it orbits, which isolates the resilient inner portion 132 of the seal member 118 relative to the orbiting follower shaft 104. In other words, the sealed roller bearing 128 orbits with the second end 122 (deflecting end) of the mount member 116 (resilient member), however the seal between the resilient inner portion 132 and the perimeter 114 of the follower shaft 104 does not deflect relative to the follower shaft 104. Therefore, this construction allows the second end 122 of the mount member 116 to deflect with the follower shaft 104 which has the effect of limiting the deflection of the resilient inner portion 132 of the seal member 118, in response to radial movement of the follower shaft 104.

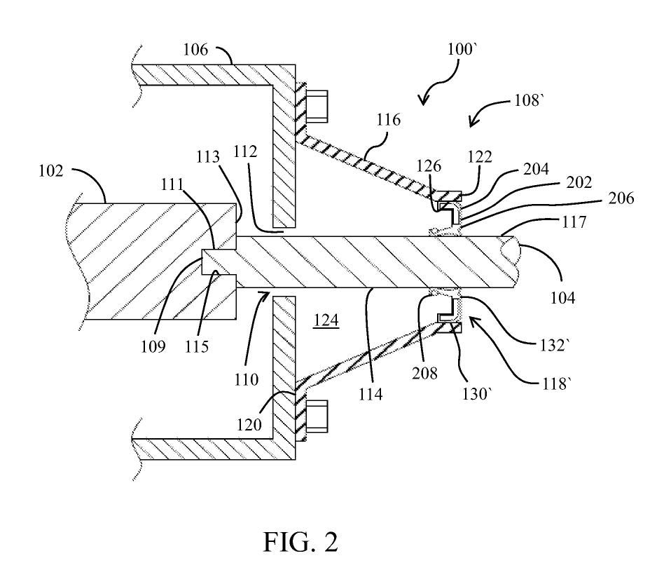

Referring to FIG. 2, there is shown a follower-shaft assembly 100′ that includes an alternative embodiment of a sealing arrangement 108′. In the alternate embodiment, the sealing arrangement 108′ employs a seal member 118′ to seal the gap 112. The seal member 118′ is a standard lip-type seal 202 mounted in the seal receiving portion 126 of the mount member 116. The seal member 118′ also includes an outer perimeter portion 130′ and a resilient inner portion 132′. The outer perimeter portion 130′ of the seal member 118′ is in engagement with the seal receiving portion 126 of the mount member 116. The resilient inner portion 132′ of the seal member 118′ is directly attached to the perimeter 114 of the follower shaft 104 to seal the perimeter 114. More particularly, the lip-type seal 202 include an outer casing 204, an inner lip portion 206, and a spring 208 disposed around the inner lip portion 206. The outer casing 204 is fixedly attached to the second end 122 of the mount member 116 and is stationary. The inner lip portion 206 is in continuous sliding contact with the perimeter 114 and the spring 208 pushes the inner lip portion 206 to seal the perimeter 114 of the follower shaft 104.

In assembly, the seal member 118′ is mounted in the second end 122 of the mount member 116. The second end 122 being made of a resilient material is designed to resiliently deflect in correspondence with the follower shaft 104 as it orbits which isolates the resilient inner portion 132′ of the seal member 118′ relative to the orbiting follower shaft 104. In other words, the lip-type seal 202 orbits with the second end 122 (deflecting end) of the mount member 116 (resilient member), however the seal between the resilient inner portion 132′ and the perimeter 114 of the follower shaft 104 does not deflect relative to the follower shaft 104. Therefore, this construction allows the second end 122 of the mount member 116 to deflect with the follower shaft 104 which has the effect of limiting the deflection of the resilient inner portion 132′ of the seal member 118′, in response to radial movement of the follower shaft 104.

### INDUSTRIAL APPLICABILITY

In operation, the follower shaft 104 may be positioned to abut or in a keyway relationship (as shown) with the base shaft 102 to suitably engage therewith and replicate the rotation of the base shaft 102. Therefore, the rotation of the base shaft 102 is determined by measuring the rotation of the follower shaft 104. The rotation of the follower shaft 104 may be determined via a rotational sensor (not shown) which may be mounted to engage the portion 117 of the follower shaft 104 and may be mounted on the housing 106, as is customary.

Referring to FIGS. 1 and 2, the sealing arrangement 108, 108′ is installed to prevent lubricant leaking past the follower-shaft assembly 100, 100′. During operation, the follower shaft 104 may displace radially and it may manifest an orbiting motion. The radial displacement and orbiting of the follower shaft 104 applies a radial and outward directed force on the resilient inner portions 132, 132′ of the seal members 118, 118′. However, since the mount member 116, 116′ is made from resilient material and the second end 122 of the mount member 116, 116′ is of smaller cross section, the second end 122 of the mount member 116 is allowed to deflect and any substantial force between the follower shaft 104 and the resilient inner portions 132, 132′ of the seal members 118, 118′ is neutralized. This limits the deflection of the resilient inner portions 132, 132′ of the seal members 118,118, in response to radial movement of the follower shaft 104. Therefore, the sealing arrangement 108, 108′ generates a much lower amount of stress on the seal members 118, 118′ due to the deflecting mount member 116, 116′ which results in a more efficient seal about the follower shaft 104 and lower stress on the seal which helps preserve the seal.

It should be understood that the above description is intended for illustrative purposes only and is not intended to limit the scope of the present disclosure in any way. Those skilled in the art will appreciate that other aspects of the disclosure may be obtained from a study of the drawings, the disclosure, and the appended claim.

What is claimed is:

1. A sealing arrangement for a follower shaft which extends within a housing to interface therewith and sense rotational movement thereof of a base shaft, the sealing arrangement comprising:
a mount member having a first end, a second end, and an opening therethrough, the first end of the mount member being attached to the housing and the follower shaft being extendable through the opening in the mount member, the second end of the mount member defining a seal receiving portion; and
a seal member having an outer perimeter portion and a resilient inner portion, the outer perimeter portion being adapted to engage with the seal receiving portion of the mount member and the resilient inner portion being adapted to seal a perimeter of the follower shaft;
wherein the second end of the mount member being structured and arranged to resiliently deflect in correspondence with the resilient inner portion of the seal member to limit a deflection of the resilient inner portion of the seal member in response to radial movement of the follower shaft.
